(19) United States
(12) Patent Application Publication
(10) Pub. No.: US 2010/0149801 A1
(43) Pub. Date: Jun. 17, 2010

(54) LED OPTICAL LENS AND ILLUMINATION DEVICE THEREOF

(75) Inventors: Chih-Wei LO, Jhonghe City (TW); I-Lin Chu, Jhonghe City (TW)

Correspondence Address: Muncy, Geissler, Olds & Lowe, PLLC, 4000 Legato Road, Suite 310, FAIRFAX, VA, 22033, US

(73) Assignee: Create Electronic Optical CO., LTD.

(21) Appl. No.: 12/509,282

(22) Filed: Jul. 24, 2009

(30) Foreign Application Priority Data
Dec. 15, 2008 (TW) 097148844

(51) Int. Cl. F21V 5/00

(52) U.S. Cl. 362/235

(57) ABSTRACT

A LED optical lens and an illumination device thereof are revealed. The optical lens includes a light-source side surface and an image side surface of the LED optical lens that both are designed respectively according to mathematical expressions of freeform surfaces such as Anamorphic formula and Toric formula Thus the optical lens has different curvatures along different axes. After light from LED emitting into the optical lens at a fixed incident angle, emergent light with different divergence angles along different axes is generated. For example, the divergence angle along the long axis is larger than that along the short axis. Therefore a uniform and near rectangular distribution pattern is formed on the target area Moreover, a plurality of optical lenses aligned along the same axes is arranged at a holder to form a lens array. The lens array is used together with a LED array so as to form a LED illumination device.

### BACKGROUND OF THE INVENTION

The present invention relates to a LED optical lens and an illumination device thereof, especially to a first LED lens or a second LED lens whose optical surfaces on a light source side and on an image side are designed according to surface definitions of freeform (mathematical expressions of freeform surfaces) so that the optical lens having different curvatures along different axes. Light emitted from LED light sources passes through the optical lens to generate a near rectangular light distribution pattern with even illumination on a target area.

LED has been applied to various fields widely, acting as light sources such as flashlights, desk lamps, vehicle lamps (headlights and/or taillights), road lights or lighting accessory of electronics such as camera flashlights, scanning light source etc. A plurality of LED is arranged into an array that works as a light source. The arrangement of LED is not restricted. It can be various patterns such as linear patterns, array patterns, or concentric circle patterns and so on according to the requirements of the illumination devices.

A LED basically consists of a base and at least one layer of cover lens. The base is loaded with at least one LED chips and is connected with a power source. The cover lens made from transparent resin or glass is called a first lens for LED that covers the LED chip to form a LED assembly (abbreviated as LED in the following). In use, light from the LED chip passes through the first lens and projects onto the target area with preset light distribution patterns.

In applications, different LED lighting devices are used under various conditions. Take road lights as an example, generally they are required to achieve even and sufficient illumination on the target area-the road surface and the ratio of the length of the luminous range to the width thereof is 3:1. The length means the distance along the direction parallel to the road direction (long axis) and the width means the distance along the direction vertical to the road direction (short axis). The distance between the two road lights is about 15 to 30 meters and the road light height is approximately 6 to 20 meters. In order to make a LED light source or a LED light array match the above requirements, besides the basic first lens, each LED is disposed with a second lens on the light emitting direction so as to improve efficiency of the LED light source by various ways such as increase of effective light intensity, adjustment of the effective area and evenness of illumination. However, in conventional road lights such as high-pressure sodium lamps, the efficiency of the light bulb is quite high but the illumination of the light is low. This is due to that the light distribution pattern generated is unable to cover the area requiring lighting and there is a certain amount of waste.

Thus the LED light source is especially suitable to be used in road lights and there is a need to develop an optical lens that generates a near rectangular light distribution pattern, high illumination and even illumination, acting as the first lens or the second lens for LED.

### SUMMARY OF THE INVENTION

Therefore it is a primary object of the present invention to provide a LED optical lens and an illumination device thereof in which a light-source side surface and an image side surface of a first LED lens (optical lens) or a second LED lens are designed by the surface definition of freeform surfaces. Thus the optical lens has different curvatures along different axes. Therefore, the effective luminance on the target area is improved and a uniform and near rectangular distribution pattern is generated. The distribution pattern is applied to road lights, vehicle lamps or camera flashlights. The distribution pattern meets requirement of the road light in which the ratio of the length along the long axis to the width along the short axis is about 3:1. The long axis is the direction parallel to the road direction while the short axis is the direction vertical to the road direction.

It is another object of the present invention to provide a LED optical lens and an illumination device thereof in which the light-source side surface of the optical lens is designed according to an anamorphic surface formula and the image-side surface of the optical lens is designed according to a toric surface formula. The light-source side surface forms an axial symmetry that is concaved inward along the long axis while the image side surface forms an axial symmetry that includes two concave parts on two sides and one concave area in the middle part along the long axis and the cross sectional view is M-shaped. Thus the effective luminance on the target area is improved and a uniform and near rectangular distribution pattern is generated.

It is a further object of the present invention to provide a LED optical lens and an illumination device thereof in which a plurality of optical lenses is acting as a second lens for LED and is arranged at a holder and is aligned along the same axes (X-axis and Y-axis) to form a lens array. Then in combination with a LED light source array, a LED illumination device is formed. Thus the effective luminance on the target area is improved and a uniform and near rectangular distribution pattern is generated. The LED illumination device is applied to road lights, vehicle lamps or camera flashlights etc.

### BRIEF DESCRIPTION OF THE DRAWINGS

FIG. 1 is a perspective view showing an image side surface of an embodiment of an optical lens (acting as second lens) according to the present invention;

FIG. 2 is a perspective view of a light source side surface of the embodiment in FIG. 1;

FIG. 3 is a front view (X-Y plane) of an embodiment of an optical lens acting as a second lens according to the present invention (labeled with size in unit of mm);

FIG. 4 is a cross sectional view of the embodiment in FIG. 3 along a line 4-4 (X-axis) and also labeled with size in unit of mm;

FIG. 5 is a cross sectional view of the embodiment in FIG. 3 along a line 5-5;

FIG. 6 is a cross sectional view of an embodiment of an optical lens acting as a second lens used in combination with a LED light source and a holder (labeled with size in unit of mm);

FIG. 7 is an assembly view of a lens array on a holder formed by a plurality of optical lenses that acts as second lens according to the present invention;

FIG. 8 shows light beams from LED light sources with the same incident angles having different divergence angles along the X-axis and the Y-axis after passing through the optical lenses;

FIG. 9 is a near rectangular light distribution pattern generated by the light having different divergence angles in the FIG. 8.

### DETAILED DESCRIPTION OF THE PREFERRED EMBODIMENT

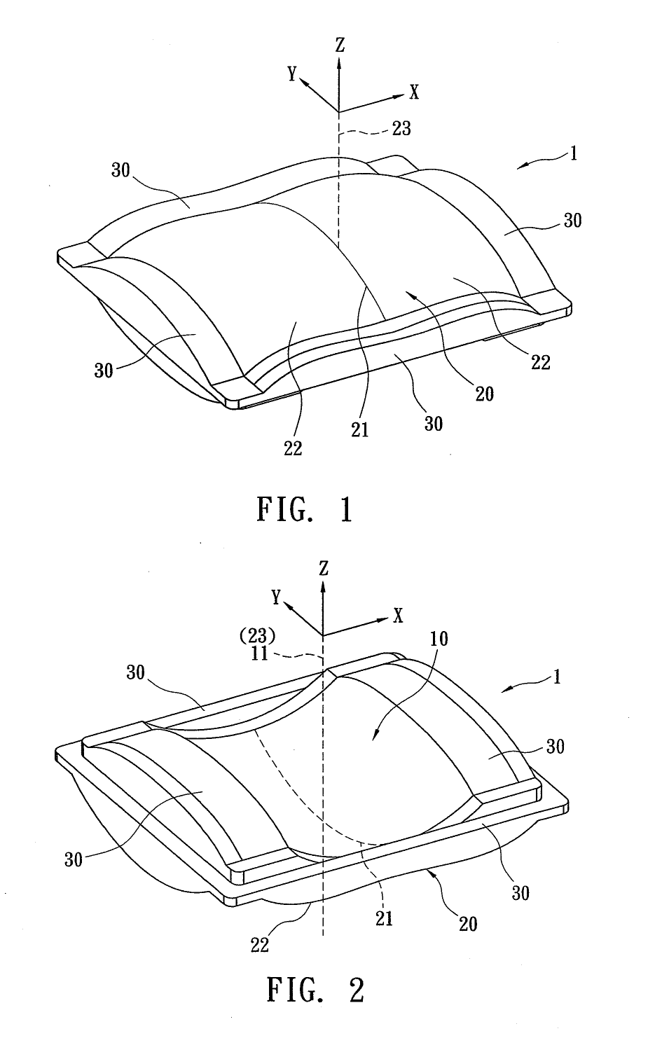

Refer from FIG. 1 to FIG. 6, an LED optical lens of the present invention can be a first lens or a second lens of LED. In this embodiment, the optical lens 1 is a second LED lens. As shown in figure, the optical lens 1 is used in combination with at least one LED 2. The optical lens 1 is a transparent lens having at least one light-source side surface 10 and one image side surface 20. Light from the LED 2 enters the optical lens 1, passes through the light-source side surface 10, the image side surface 20 and projects to the target area.

The present invention features on that: the light-source side surface 10 and the image side surface 20 are designed according to mathematical expressions of freeform surfaces. The mathematical expressions of freeform surfaces known in the optical field include a plurality of equations applied to the design of optical surfaces on lenses such as the following equation (1)—Anamorphic formula and the equation (2)—Toric formula. equation (1) Anamorphic formula:

$$Z = \frac{( Cx ) {X}^{2} + ( Cy ) {Y}^{2}}{1 + \sqrt{1 - ( 1 + Kx ) {( Cx )}^{2} {X}^{2} - ( 1 - Ky ) {( Cy )}^{2} {Y}^{2}}} + {\sum }_{i = 1}^{20} {A}_{2 i} {\{ ( 1 - {B}_{2 i} ) {X}^{2} + ( 1 + {B}_{2 i} ) {Y}^{2} \}}^{i}$$

equation (2) Toric formula:

$$Zx = \frac{( Cx ) {X}^{2}}{1 + \sqrt{1 - ( 1 + Kx ) {( Cx )}^{2} {X}^{2}}} + {\sum }_{i = 1}^{20} {A}_{i} {X}^{i} , \\ Cyx = \frac{1}{( 1 \text{/} Cy ) - Zx}$$

$$Z = Zx + \frac{( Cyx ) {Y}^{2}}{1 + \sqrt{1 - {( Cyx )}^{2} {Y}^{2}}}$$

wherein while designing the light-source side surface 10 and the image side surface 20 of the optical lens 1, each optical parameter in the Anamorphic formula (equation (1)) and the Toric formula (equation (2)) can be modified and then run a computer simulation to see if the design of the optical lens 1 works.

By the mathematical expressions of freeform surfaces, the formed two optical surfaces—the light-source side surface 10 and the image side surface 20 are both continuous surfaces. This is beneficial to manufacturing of optical lens 1 molds. Thus the processing of the mold is getting easier. Moreover, this is also advantageous for the two optical surfaces 10, 20 to achieve optical grade precision.

In the optical lens 1 in this embodiment, the light-source side surface 10 is designed by the Anamorphic formula, formed an axial symmetry that is concaved inward along the long axis, as shown in FIG. 2 and FIG. 4. As to the image side surface 20, it is designed according to the Toric formula, forming an axial symmetry with two concave parts 22 on two sides and one concave area 21 in the middle part, look like a M-shape, as shown in FIG. 1 and FIG. 4. And the light-source side surface 10 corresponds to the image side surface 20.

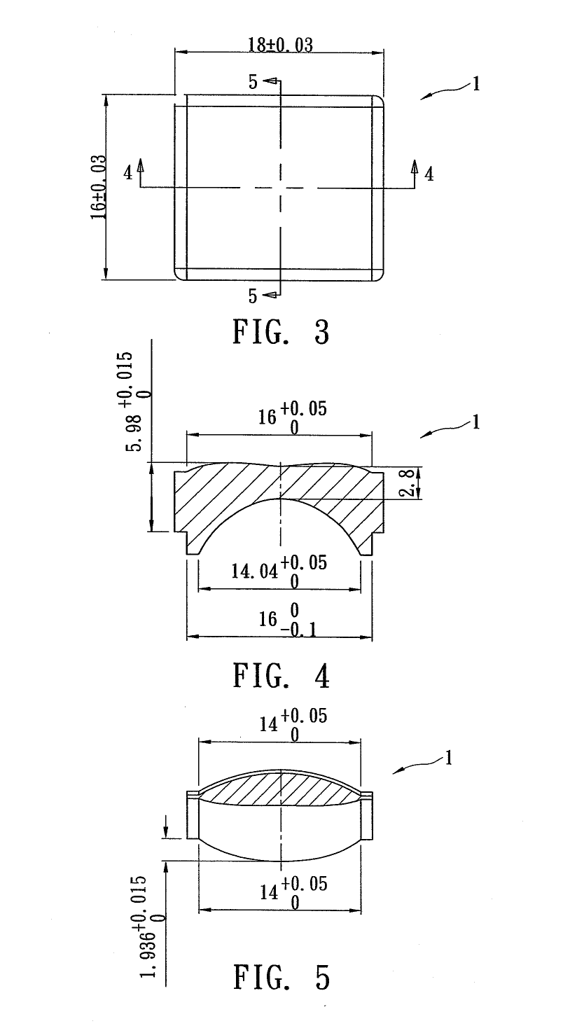

Refer from FIG. 3 to FIG. 5, an embodiment of the optical lens 1 shows feasible size. According to the requirement of road light, the ratio of the length along the X-axis (long axis, along the road) to the width along the Y-axis (short axis, perpendicular to the X-axis) thereof is 3:1. The optical parameters in the equation (1) and the equation (2) are modified and are simulated using computer software so as to finish the design of the optical lens 1. As to non-optical parts such as an outer part 30 surrounding the light-source side surface 10 and the image side surface 20, there is no limit on its shape and structure and it can be modified according to the requirements for assembling. As shown from FIG. 1 to FIG. 5, the optical lens 1 in the embodiment is a second lens for LED and is designed into a rectangular lens. The outer part 30 thereof is designed according to the shape of a hole 41 disposed on a holder 4 of an illumination device 3.

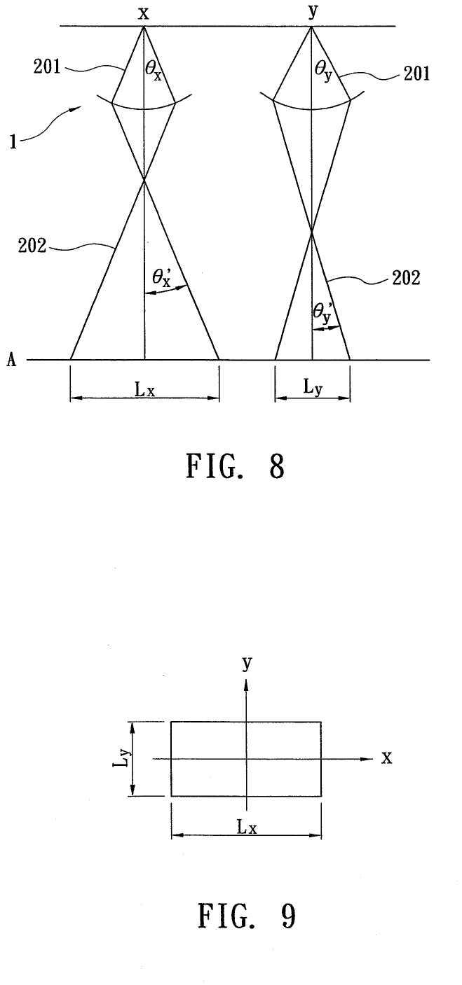

By the correspondence between the light-source side surface 10 and the image side surface 20, the X-axis (long axis) and the Y-axis (short axis) of the optical lens 1 have different curvature radii. Thus light 201 emitted from the LED 2 is refracted and having different divergence angles along the X-axis and the Y-axis so as to form a rectangular distribution pattern, as shown in FIG. 8. The light beam 201 emitted from the LED 2 is incident toward the optical lens 1 at a fixed incident angle θx, θy and then is out of the optical lens 1 to be projected to a target area A. Because the X-axis and the Y-axis of the optical lens 1 have different curvature radii, emergent light 202 with different divergence angles are generated along the X-axis and on the Y-axis respectively. Refer to FIG. 8, the divergence angle θ′x of the emergent light 202 along the X axis is larger than the divergence angle θ′y along the Y axis. Thus on the target area A, the illumination (light) range Lx of the emergent light 202 formed along the X-axis is larger than the light range Ly of the emergent light 202 formed along the Y-axis. And a rectangular light distribution pattern in which the ratio of length to width is about Lx:Ly is generated on the target area A, as shown in FIG. 9. Refer to the optical lens 1 and the illumination device 3 of the embodiment in FIG. 1 to FIG. 6, light emitted from the LED 2 is refracted by the optical lens 1 to generate a near rectangular light distribution pattern in which the ratio of the length along the X-axis to the width along the Y-axis is about 3:1. The pattern matches the light distribution pattern with specific ratio and uniformity of illuminance required by road lights. As to the ratio of the length to the width, it can be changed according to the requirements of the optical lens 1 by modifying the optical parameters in the equations and using computer software for simulation of the parameters so as to make the designed optical lens 1 have optimal effects.

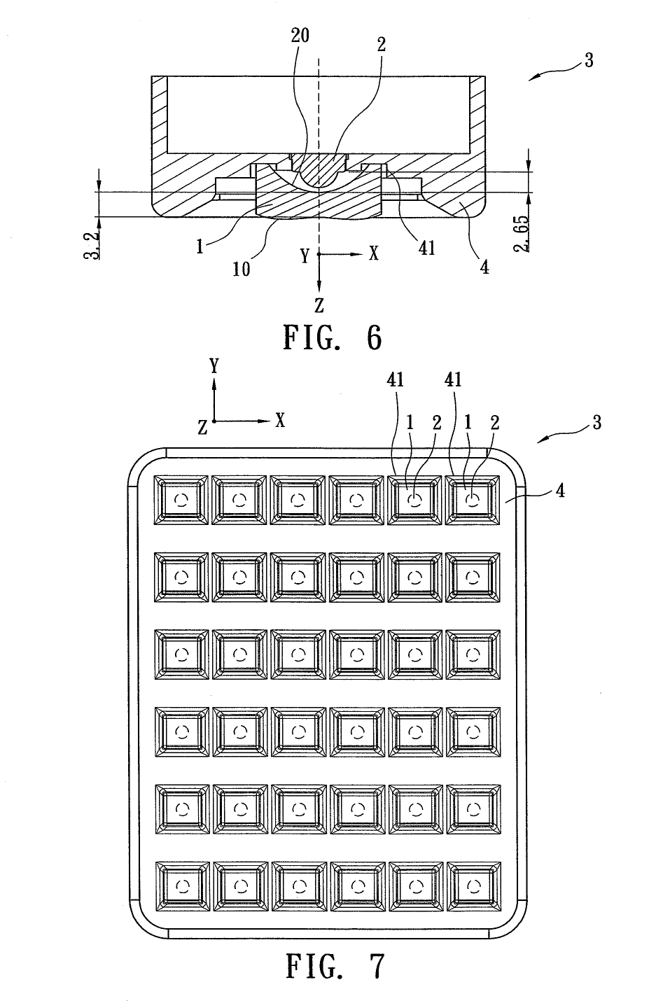

Refer to FIG. 6 and FIG. 7, the LED illumination device 3 of the present invention consists of at least one LED 2, at least one optical lens 1 and a holder 4. There is no limit on the shape, size, assembling way of the LED illumination device 3 as well as the correspondence between the LED 2 and the optical lens 1. For example, one LED 2 or two LEDs 2 are disposed corresponding to one optical lens 1. Their designs can be modified according to different requirements in different applications such as road lights, vehicles lamps, camera flashlights, and so on. As shown in FIG. 7, a road light or similar object is taken as an example. As shown in FIG. 6 and. FIG. 7, the optical lens 1 in this embodiment is used in combination with a LED 2. As shown in FIG. 3 to FIG. 5, the optical lens 1 is designed according to requirements of a road light and the LED 2 is disposed on a concave surface of the light source side surface 10. Moreover, a plurality of optical lenses 4 is aligned along the same axes. That means the X-axis as well as the Y-axis of the optical lenses 1 are in the same direction. Thus a lens array is formed on a holder 4 with larger size, as shown in FIG. 7. A 6×6 LED array constituting a LED illumination device 3 is revealed in FIG. 7. Therefore, the light loss during transmission is reduced, the effective luminance of the LED light source is improved and a near rectangular light distribution pattern with even luminance is generated on the target area Furthermore, the LED illumination device 3 formed by the 6×6 lens array in FIG. 7 is designed for road lights. The arrangement of the lenses is not limited and is modified according to different requirements in use. For example, the lens array can be a 5×4 or 2×1 array or the lenses are arranged in other ways such as linear patterns, concentric circular patterns, or staggered patterns for being applied to other illumination devices such as vehicle lamps or camera flashlights.

There is no limit on the shape, assembling ways and the size of the holder 4 and all can be changed according to different requirements in different application fields. For example, the holder 4 can be an integrated part made by plastic injection molding, as shown in FIG. 6 & FIG. 7. Or it can also be a combination of multiple parts (not shown in figure). The holder 4 is disposed with at least one hole 41. In FIG. 6, the holder 4 is disposed with a hole 41. Refer to FIG. 7, the holder 4 is disposed with a plurality of holes 41 that forms a hole array. Each hole 41 is mounted with an optical lens 1 so as to form a lens array, as a 6×6 lens array in FIG. 7, but not limited to the 6×6 lens array. Each optical lens 1 is corresponding to a LED 2 to form a LED illumination device 3. In the embodiment in FIG. 1 to FIG. 7, the shape of the optical lens 1 (that's the outer part 30) and the size thereof are designed according to the hole 41 on the holder 4. Thus the optical lens 1 is mounted in and the hole 41 correspondingly and is integrated into one part. The connection way between the optical lens 1 and the hole 41 is by glue but not limited to this way. And it's optimal that the connection way can provide waterproof effects.

In the LED illumination device 3, at least one hole 41 is disposed on the holder 4 and the hole 41 is mounted with an optical lens 1 correspondingly. Thus the holder 4 and the optical lens 1 are manufactured separately. The shape of the hole 41 basically is designed according to the shape of the optical lens 1 being mounted therein. Therefore, the design of the mold, manufacturing and production processes of the optical lens 1 are simplified. Moreover, the optical surface of the optical lens 1 is easy to achieve optimal design. This is beneficial to improvement of the optical efficiency and the assembling of the LED illumination device 3 is simplified relatively.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A light-emitting diode (LED) optical lens that is a transparent lens and is used in combination with a LED light source comprising a light-source side surface and an image side surface, wherein
the light-source side surface is defined by mathematical expressions of freeform surfaces and is facing at least one LED light source so that light from the at least one LED light source emits into the optical lens through the light-source side surface;
the image side surface is facing a target area and is defined by mathematical expressions of freeform surfaces while light from the LED light source passes through the light-source side surface, into the optical lens and out of the image side surface to be projected into the target area;
wherein light from the LED light source is refracted by the optical lens to generate a near rectangular light distribution pattern on the target area due to the light-source side surface and the image side surface defined by mathematical expressions of freeform surfaces and there is a ratio of a length along a long axis to a width along a short axis of the near rectangular light distribution pattern.

2. The device as claimed in claim 1, wherein the light-source side surface is defined by following Anamorphic formula:
$$Z = \frac{( Cx ) {X}^{2} + ( Cy ) {Y}^{2}}{1 + \sqrt{1 - ( 1 + Kx ) {( Cx )}^{2} {X}^{2} - ( 1 + Ky ) {( Cy )}^{2} {Y}^{2}}} + {\sum }_{i = 1}^{20} {A}_{2 i} {\{ ( 1 - {B}_{2 i} ) {X}^{2} + ( 1 + {B}_{2 i} ) {Y}^{2} \}}^{i}$$
and the light-source side surface forms an axial symmetry that is concaved inward along a long axis thereof.

3. The device as claimed in claim 1, wherein the image side surface is defined by following Toric formula:
$$Zx = \frac{( Cx ) {X}^{2}}{1 + \sqrt{1 - ( 1 + Kx ) {( Cx )}^{2} {X}^{2}}} + {\sum }_{i = 1}^{20} {A}_{i} {X}^{i} , \\ Cyx = \frac{1}{( 1 \text{/} Cy ) - Zx}$$
$$Z = Zx + \frac{( Cyx ) {Y}^{2}}{1 + \sqrt{1 - {( Cyx )}^{2} {Y}^{2}}}$$
and the image side surface forms an axial symmetry with two concave parts on two sides and one concave area in a middle part thereof, like a M-shape.

4. The device as claimed in claim 1, wherein optical parameters of the mathematical expressions of freeform surfaces are modified and are simulated using computer software so as to design the ratio of the length along the long axis to the width along the short axis of the near rectangular light distribution pattern.

5. The device as claimed in claim 1, wherein the ratio of the length along the long axis to the width along the short axis of the near rectangular light distribution pattern generated on the target area by the optical lens is 3:1.

6. The device as claimed in claim 1, wherein the optical lens further includes an outer part disposed around the light-source side surface and around the image side surface.

7. A light-emitting diode (LED) illumination device comprising at least one optical lens, at least one LED light source and a holder, wherein
the optical lens having at least one light-source side surface and at least one image side surface is a transparent lens and is mounted in a hole disposed on the holder correspondingly; the light-source side surface and the image side surface are designed by mathematical expressions of freeform surfaces;
the LED light source faces the light-source side surface of the optical lens;
the holder is disposed with at least one hole that is mounted with an optical lens;
wherein light emitted from the LED light sources emits into the optical lens through the light-source side surface of the optical lens and out of the image side surface to be projected into a target area; by the light-source side surface and the image side surface designed according to mathematical expressions of freeform surfaces, a near rectangular light distribution pattern is generated on the target area and there is a ratio of a length along a long axis to a width along a short axis of the near rectangular light distribution pattern.

8. The device as claimed in claim 7, wherein the optical lens further includes an outer part that is designed according to the hole disposed on the holder so that the optical lens is mounted into and integrated with the hole correspondingly.

9. The device as claimed in claim 7, wherein the holder is disposed with a plurality of holes that forms a hole array.
